(19) United States
(12) Patent Application Publication
(10) Pub. No.: US 2007/0282470 A1
(43) Pub. Date: Dec. 6, 2007

(54) Method and system for capturing and reusing intellectual capital in IT management

(75) Inventors: Milton H. Hernandez, Tenafly, NJ (US); Gopal Sarma Pingali, Mohegan Lake, NY (US); Prashant Pradhan, Mamaroneck, NY (US)

Correspondence Address: CAHN & SAMUELS, LLP, 2000 P. STREET, NW, SUITE 200, WASHINGTON, DC, 20036, US

(73) Assignee: International Business Machines Corporation, Armonk, NY (US)

(21) Appl. No.: 11/446,513

(22) Filed: Jun. 5, 2006

(51) Int. Cl. G06F 17/00

(52) U.S. Cl. 700/90

(57) ABSTRACT

A method and system for generating a graph-based model of an IT system that experiences certain undesirable events. The graphical representation of the IT system and its events is used to resolve other undesirable events occurring on the same system or a similar system and is also used to manage changes within the IT system.

### FIELD OF THE INVENTION

The present invention generally relates to a method and system for capturing problem scenarios on an IT system and reusing knowledge gained by analyzing the scenarios to manage future system configuration changes and also to manage future problems arising in similarly configured IT systems. More particularly, the present invention is directed to a method and system for generating and storing a graphical representation of relationships between problematic events occurring on an IT system and relevant system components. Future users of the same system, or similarly configured system, search the stored graphical information to resolve or otherwise avoid problematic events that have previously been recognized.

### BACKGROUND OF THE INVENTION

Management of IT systems, e.g., solving problems and implementing change, is a highly knowledge-based, human-resource intensive process. Additionally, significant costs are associated with the acquisition of system expertise and the knowledge attendant therewith. Accordingly, when experienced people leave an organization and take gained expertise with them, organizations face undesirable costs associated with the departure. Further, in addition to the financial costs associated with the re-acquisition of the departed expertise with new people, there also exists significant non-financial cost associated with “warm up” time while the new people gain the necessary expertise sufficient to provide a similar level and quality of problem management as the lost experienced personnel. For example, time is lost with respect to the enterprise while the new personnel are gaining the experience.

Typically, knowledge with respect to IT system failures and their corresponding fixes are captured in unstructured form, for instance, using natural language. For example, one might search a problem log as follows: “look for symptom X associated with error code Y in log Z.” A result of this type of query might be: “the problem could be high queue utilization, check buffers.” If high queue utilization turns out to be the problem, it might then be determined that the most likely cause is the failure of a downstream job and further investigation is necessary. This manner of problem solving and the associated data storage is very cumbersome. It is also very difficult to achieve consistency and structure in recording problem patterns and resolutions.

The present invention addresses the above and other issues with respect to problem resolution and avoidance in an IT environment by providing a novel graph-based information model to structure IT systems management knowledge, making it suitable for search and reuse. One important advantage gained by employing a method and system consistent with the invention is that the need for a human to communicate the problem symptom in detail, such as by using natural language queries, is eliminated. Instead, the problem symptom and the corresponding system signature are automatically derived from the system providing a detailed and accurate snapshot of the system during actual system runtime.

### SUMMARY OF THE INVENTION

Illustrative, non-limiting embodiments of the present invention address the aforementioned and other disadvantages associated with related art methods of IT system problem resolution and avoidance.

Virtually all IT systems are characterized by inherent structure that comes from system configuration and dynamic interaction between various components. This structure can be used to relate events and symptoms occurring in the system with each other. A systematic representation of this structure is a graph or network representation using nodes to represent system entities, including hardware and software components and event components, and edges to represent relationships between the entities. Thus, any system problem can be characterized in a uniform manner by capturing the specific graph for that problem. Similarly, any system change can be captured by a change in this graph structure. Systems and methods in accordance with the present invention utilize the relationship graph structure as a means to represent and search for any previously identified IT systems management scenario in order to manage problem resolution and change management within an IT system.

In accordance with one exemplary embodiment, a method of capturing and reusing intellectual capital regarding an IT system is provided, the method comprising, generating a graphical representation of a relationship between hardware and software components of the IT system, identifying event data that is descriptive of a first undesirable event relative to the IT system, associating the event data identified with the graphical representation of the relationship between hardware and software components of the IT system to create an updated system graph, inputting data representative of a second undesirable event, and comparing the updated system graph to the inputted data to at least partially resolve the second undesirable event.

In accordance with a further exemplary embodiment, a method for managing a change in a first IT system is provided, the method comprising, generating a graphical representation of a relationship between hardware and software components of a second IT system, identifying event data that is descriptive of a first undesirable event relative to the second IT system, associating the event data identified with the graphical representation of the relationship between hardware and software components of the second IT system to create an updated system graph, inputting data representative of a desired change to the first IT system, comparing the updated system graph to the inputted data, and determining whether the desired change to the first IT system is viable based on results of the comparison of the updated system graph to the inputted data.

In accordance with an even further exemplary embodiment, a computer program product for providing a service to reuse IT system knowledge is provided, the program product comprising a computer readable medium, first program instruction means for generating a graphical representation of a relationship between hardware and software components of the IT system, second program instruction means for identifying event data that is descriptive of a first undesirable event relative to the IT system, and third program instruction means for overlaying the identified event data onto the graphical representation of the relationship between hardware and software components of the IT system to create an updated system graph.

According to an even further exemplary embodiment of the invention, a database for providing information regarding an IT system is provided, the database comprising, a first portion for providing information regarding a relationship between at least one of hardware and software components of the IT system and a second portion for providing information regarding an association between at least one event and the at least one of hardware and software components.

According to an yet even further exemplary embodiment of the invention, a system for resolving an undesirable event in an IT network is provided, the system comprising, a first graph generating portion operable to generate a graphical representation of relationships between at least one of hardware and software components of the IT network, an event identification portion operable to identify a first undesirable event that has occurred within the IT network, and a resolver portion comprising at least an association portion operable to associate the first undesirable event with at least one component within the graphical representation of the at least one of hardware and software components of the IT network.

### BRIEF DESCRIPTION OF THE FIGURES

FIG. 1 is a general conceptual process map of an IT system in accordance with the present invention.

FIG. 2 is a hardware configuration diagram of an IT system and related events in accordance with the invention.

FIG. 3 is a conceptual diagram illustrating the relationship between particular events and related components of the IT system in accordance with the present invention.

FIG. 4 is a detailed conceptual diagram illustrating the relationship between certain events and various system components in accordance with the present invention.

FIG. 5 is a conceptual diagram illustrating a basic overall embodiment in accordance with the present invention.

### DETAILED DESCRIPTION OF EXEMPLARY EMBODIMENTS

The present invention is related to the IT services area and, thus many technology-specific terms are used in describing the invention and providing the environment in which it operates. Skilled artisans would understand the intended meaning of the technology-specific terms used below, however, the following, non-exhaustive list of term definitions is provided to assist the reader. Although the list of terms below provides a general definition of the respective terms, the definitions provided are not meant to be limiting. That is, the definitions provided are not exclusive and one skilled in the art should apply alternative or modified definitions where appropriate.

CRM: (Customer Relationship Management) An integrated information system that is used to plan, schedule and control the pre-sales and post-sales activities in an organization. CRM embraces all aspects of dealing with prospects and customers, including the call center, sales force, marketing, technical support and field service. The primary goal of CRM is to improve long-term growth and profitability through a better understanding of customer behavior. CRM aims to provide more effective feedback and improved integration to better gauge the return on investment (ROI) in these areas.

DB2: (DATABASE 2) A relational DBMS from IBM that was originally developed for its mainframes. It is a full-featured SQL language DBMS that has become IBM's major database product. Known for its industrial strength reliability, IBM has made DB/2 available for all of its own platforms, including OS/2, OS/400, AIX (RS/6000) and OS/390, as well as for Solaris on Sun systems and HP-UX on HP 9000 workstations and servers.

DB2 UDB: (DB2 Universal DataBase) An enhanced and very popular version of DB2 that combines relational and object database technology as well as various query optimization techniques for parallel processing. Also geared for electronic commerce, DB2 UDB provides graphical administration, Java and JDBC support. DB2 UDB runs on mainframes, Windows NT/2000 and various versions of Unix.

Java: An object oriented programming language that is platform independent (the same Java program runs on all hardware platforms without modification). Developed by Sun, Java is widely used on the Web for both client and server processing. Modeled after C++, Java added programming enhancements such as “garbage collection,” which automatically frees unused memory. It was also designed to run in small amounts of memory. The first Web browsers to run Java were Sun's HotJava and Netscape Navigator 2.0.

JDBC: (Java DataBase Connectivity) A programming interface that lets Java applications access a database via the SQL language. Since Java interpreters (Java Virtual Machines) are available for all major client platforms, this allows a platform-independent database application to be written.

JVM: (Java Virtual Machine) A Java interpreter. The Java Virtual Machine (JVM) is software that converts the Java intermediate language (bytecode) into machine language and executes it.

Middleware: Software that provides an interface between applications, allowing them to send data back and forth to each other asynchronously. Data sent by one program can be stored in a queue and then forwarded to the receiving program when it becomes available to process it. Without using a common message transport and queueing system such as this, each application must be responsible for ensuring that the data sent is received properly. Maintaining communications between different types of applications as they are revised and eventually replaced with newer architectures creates an enormous programming burden in the large enterprise.

MQSeries: Messaging middleware from IBM that allows programs to communicate with each other across all IBM platforms, Windows, VMS and a variety of Unix platforms. Introduced in 1994, it provides a common programming interface (API) that programs are written to. The MQ stands for Message Queue.

Native Application: An application designed to run in the computer environment (machine language and OS) being referenced. The term is used to contrast a native application with an interpreted one such as a Java application that is not native to a single platform. The term may also be used to contrast a native application with an emulated application, which was originally written for a different platform.

NetView: An IBM System Network Architecture (SNA) network management software application that provides centralized monitoring and control for SNA, non-SNA and non-IBM devices. NetView/PC interconnects NetView with Token Ring LANs, Rolm CBXs and non-IBM modems, while maintaining control in the host.

OMEGAMON: A family of performance tools for S/390 environments from Candle that monitor processing activities of major systems programs such as MVS, CICS and DB2.

Tivoli: Systems Management Software (SMS). A comprehensive suite of applications from IBM subsidiary Tivoli Systems, Inc., Austin, Tex. that provides enterprise-wide network and systems management across all platforms from IBM mainframes to desktop PCs. Tivoli covers security, storage, performance and availability, configuration and operations.

WebSphere: An IBM brand of products that implement and extend Sun's JavaTwoEnterpriseEdition (J2EE) platform. The Java-based application and transaction infrastructure delivers high-volume transaction processing for e-business and provides enhanced capabilities for transaction management, as well as security, performance, availability, connectivity, and scalability.

Wrapper: A data structure or software that contains (“wraps around”) other data or software, so that the contained elements can exist in the newer system. The term is often used with component software, where a wrapper is placed around a legacy routine to make it behave like an object. This is also called “encapsulation” or “wrapper encapsulation,” but is not the same as “object encapsulation,” a fundamental concept of object technology.

Exemplary, non-limiting, embodiments of the present invention are discussed in detail below. While specific configurations and process flows are discussed to provide a clear understanding of the invention, it should be understood that the disclosed process flows and configurations are provided for illustration purposes only. A person skilled in the relevant art will recognize that other process flows and configurations may be used without departing from the spirit and scope of the invention.

Virtually all IT systems are characterized by inherent structure that results from the overall system hardware configuration as well as dynamic interaction between various hardware and software components. In accordance with the invention, this known structure is used to relate events that occur within the system to particular symptoms that occur as a direct or indirect result of the event. For example, an event such as one software application attempting to transfer data or otherwise communicate with a second software application might cause the system to crash or otherwise fail, an obviously undesirable symptom. Typically, when such an event occurs, the symptom is logged into on an error log so human users can search the log later to avoid or resolve similar problems.

In accordance with the present invention, relationships between the events and any undesirable symptoms are tracked graphically to help avoid the undesirable symptoms in the future by providing an efficient means for searching. That is, a systematic representation of the system structure is prepared, such as by generating a “graph” or network representation of the system using “nodes” to represent system entities, and “edges” to represent relationships of events and symptoms. Thus, any system problem can be characterized in a uniform manner by capturing the specific graph for that problem. Similarly, system changes can be captured by identifying a change in the structure of the graph. In accordance with at least one embodiment of the invention, the resulting relationship graph structure is one means by which previously occurring IT systems management scenarios are represented and then searched for when desired.

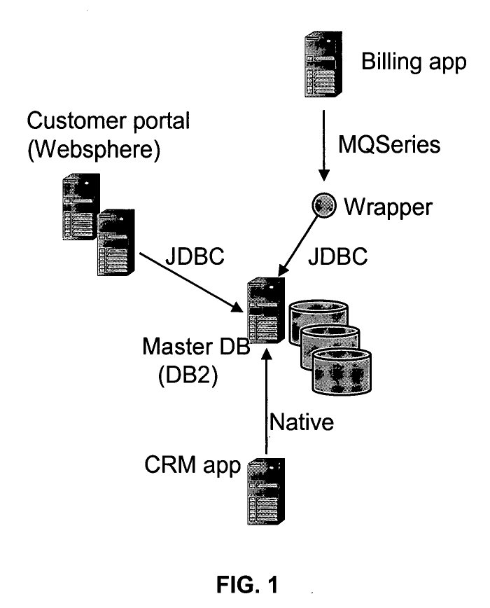

FIG. 1 illustrates a possible exemplary hardware/process map for a system that would benefit from utilizing a method in accordance with the present invention. In the exemplary system of FIG. 1, four servers are shown, each either directly or indirectly communicating with a database. Two servers operate as a customer portal running Websphere, one server is running a billing application and one server is running a CRM application. The customer portal communicates with a master DB2 database via JDBC middleware, the CRM application communicates with the DB2 database via a native application and the billing application communicates with a wrapper product via MQSeries middleware with the wrapper, in turn, communicates with the DB2 database using JDBC middleware.

The various processes running on the servers and the various associated transfer of information between the servers and database using various different middleware products potentially results in many different hardware/software configuration scenarios for which problematic events may occur. As will be discussed, systems and methods in accordance with the present invention capture the various possible scenarios and any associated problematic events that occur while the processes are running. A graphical representation of the relationships is then created.

Problematic events are captured using any of a combination of tracking products, such as Websphere, Tivoli, etc. Hardware and software relationships are captured and presented in a graphical form and then the graph is updated by overlaying event occurrences onto the configuration graph. A problem resolver (not shown in FIG. 1) then accepts inputted data, e.g., regarding a similar symptom or a system change, from a user and searches the updated graph for occurrences where the same event and configuration data were captured.

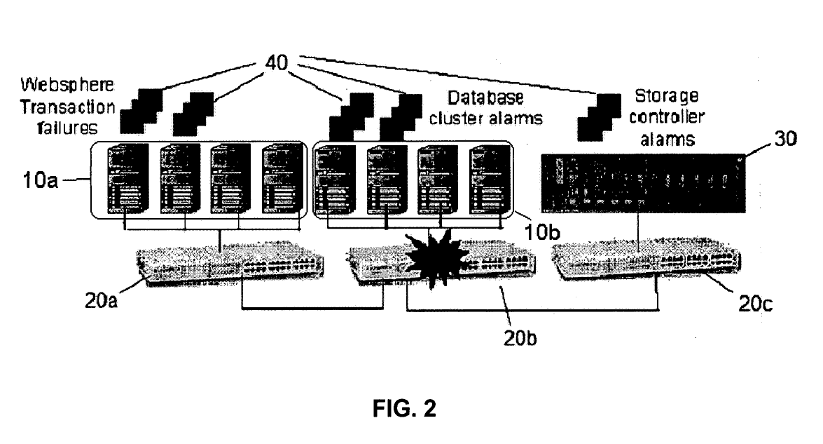

FIG. 2 illustrates an exemplary structural system model in accordance with the present invention. More particularly, similar to the system shown in FIG. 1, FIG. 2 represents an IT system comprising various hardware components that communicate with each other to perform desired tasks. FIG. 2 additionally includes various events. Two clusters of four servers, 10a and 10b, are connected to each other by a network of switches 20a and 20b. Additionally, the two server clusters are connected to a storage device 30 via a switch 20c.

Also shown in FIG. 2 are a number of individual events. These events are expressed as a number of square “nodes” 40. For example, in accordance with the present embodiment, the events 40 are grouped into several discrete groups, i.e., Websphere Transaction Failures, Database Cluster Alarms, Storage Controller Alarms and Network Port Events.

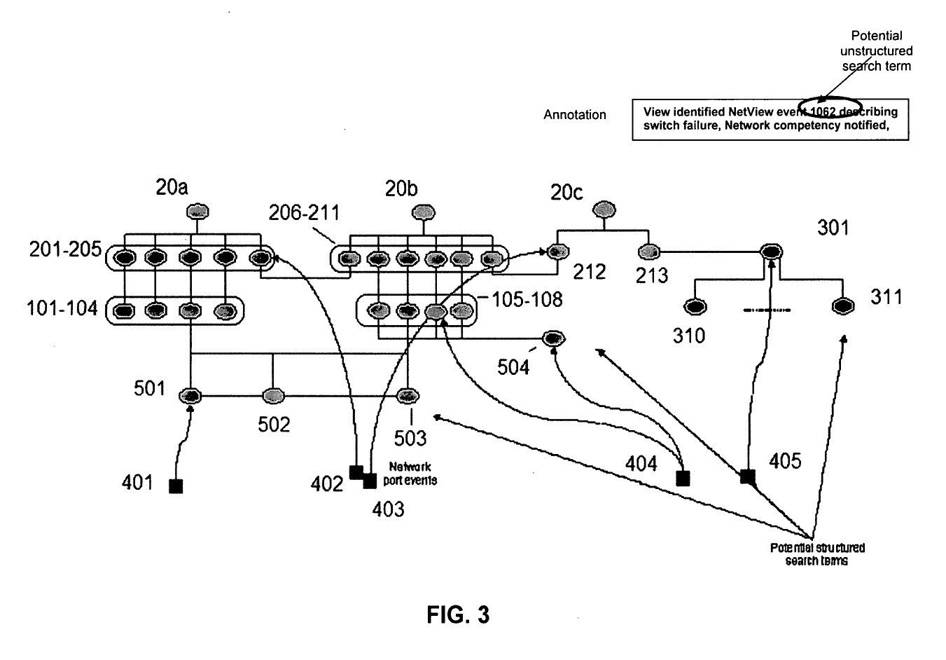

FIG. 3 is a graph-based representation of the system components of FIG. 2 and their relationships to each other. Specifically, each oval-shaped object in FIG. 3 represents an individual hardware or software component of the system. That is, servers 101-104 represent the four servers of cluster 10a in FIG. 2 and servers 105-108 represent the four servers corresponding to cluster 10b. Additionally, switch ports 201-205 represent five respective ports of switch 20a in FIG. 2, switch ports 206-211 represent six ports of switch 20b and switch ports 212 and 213 represent ports of switch 20c. Component 301 is a disk array controller within storage device 30 (FIG. 2) and components 310 and 311 are disks within storage device 30 (FIG. 2).

Software components are also shown in FIG. 3. In particular, component 501 is a Websphere application, such as Pet Store, 502 is a JDBC data source and 503 is a back-end database for use with the Pet Store Websphere application. The lines in FIG. 3 connecting the components represent the relationship between the various components.

The relationship between hardware and software system components and the events mentioned above is also shown in FIG. 3. For example, the arrow between the Websphere transaction failure event 401 and the Websphere application component 501 indicates that the Websphere transaction failure 401 has been determined to be related to the Websphere application 501. Further, one of the Network port events, 402, is related to switch port 205 and another Network port event, 403, is related to switch port 212. Further, Database cluster alarm event 404 is related to server 107 as well as to DB2 cluster 504. Lastly, storage controller alarm event 405 is related to disk array controller 301. Other events shown in FIG. 2 but not shown in FIG. 3 are similarly related to respective hardware and/or software system components. However, for sake of clarity only the events mentioned above and their relationships with various components are shown in FIG. 3.

With respect to FIG. 3, the structural configuration of the system i.e., the interconnection of all of the system components, comprises a number of static and dynamic relationships. Static relationships between components can be inferred from the system configuration, e.g., which server is connected to which switch port. Such relationships are typically maintained in system configuration files, or in some cases static relationships are “discovered” through the use of software tools. For example, NetView and various Collation products, both from IBM, can be used to derive the static configuration of the system. NetView can be used to derive the topology and the server-network connectivity, for example. Other products known to those of skill in the art can also be used provided the static configuration of the system is determined and made accessible.

Alternatively, dynamic relationships are relationships that are established as the system is running, e.g., communication relationships between various system processes. Such dynamic relationships are discovered by observing events from the system. For example, middleware, such as MQSeries and JDBC, capture dynamic relationships as processes run on the system. That is, when an event occurs, e.g., a transaction error or some sort of alarm, a middleware log is updated indicating the particular event and to which system component or components that particular event is related. Accordingly, as various processes are run on the system, a database is maintained that indicates each event and the system components related to those events.

At the upper portion of FIG. 3 a natural language annotation is provided. This annotation is exemplary of the type of annotation that might be provided in related art systems but which does provide adequate information to efficiently resolve the problems. In accordance with the present invention, this annotation can be added to the graphical representation of the system event/component relationships.

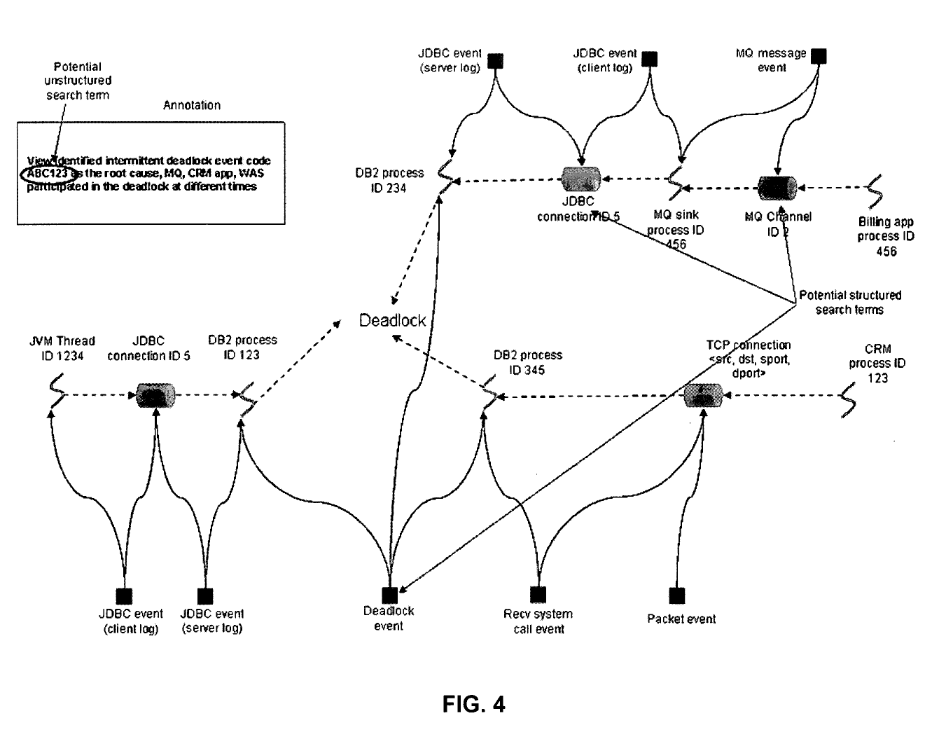

FIG. 4 represents a detailed graph-based model of a system with its respective event/component relationships illustrated. That is, by using known configuration files, discovery tools and event processing, a graph such as that shown in FIG. 4 is derived and maintained in accordance with the invention for various system/event activities. The graph of FIG. 4 includes the process JVM thread 1234 communicating with the DB2 process 123, over JDBC connection ID 5. According to the invention, various events are determined to be related to each of these processes, or components, by analyzing two events, one each from the client and server JDBC log. That is, by analyzing the client log, generated for example by the JDBC interface program, the relationship between the JVM thread 1234 and the JDBC connection ID 5 is established. Further, by analyzing the JDBC server log, the relationship between the JDBC connection ID 5 and the DB2 process ID 234 is established.

After the event/component-relationship graph is established for the various events, it then possible for users to resolve a problematic event on the same or similar system by querying the graphical database. That is, in accordance with this embodiment, the user enters, into a system application consistent with the invention, logical expressions representative of his or her system along with event information. The graphical database is then searched in order to find one or more graphs indicative of the problem.

For example, in a first step of a method according to the invention, for a given problem scenario, a relationship graph is generated as discussed above to capture the problem pattern. For a given system configuration, a relationship graph is generated to capture the state of the system. Next, a problem resolver annotates the graph with natural language comments, and optionally edits the graph to remove or collapse redundant nodes/edges. Thereafter, when a particular change in the system results in a problem in operations, the problematic configuration is tagged as “bad.”

After the graph database is established, the database is searched to discover a graphical match for a given problem scenario. For example, a problem, resulting in a specific error code 1052, may have arisen while running a particular application, such as SAP, on the AIX operating system. To resolve the problem, a user would enter into the system resolver nodes X, Y and Z. Node X is entered as type “OS” (operating system) and given a value “AIX”, indicating the AIX operating system. Node Y is given type “App” for application and given a value “SAP.” The resolver then searches the graphical database and returns all graph instances that have all of nodes X, Y and Z. In this manner historical data is used to expedite problem resolution.

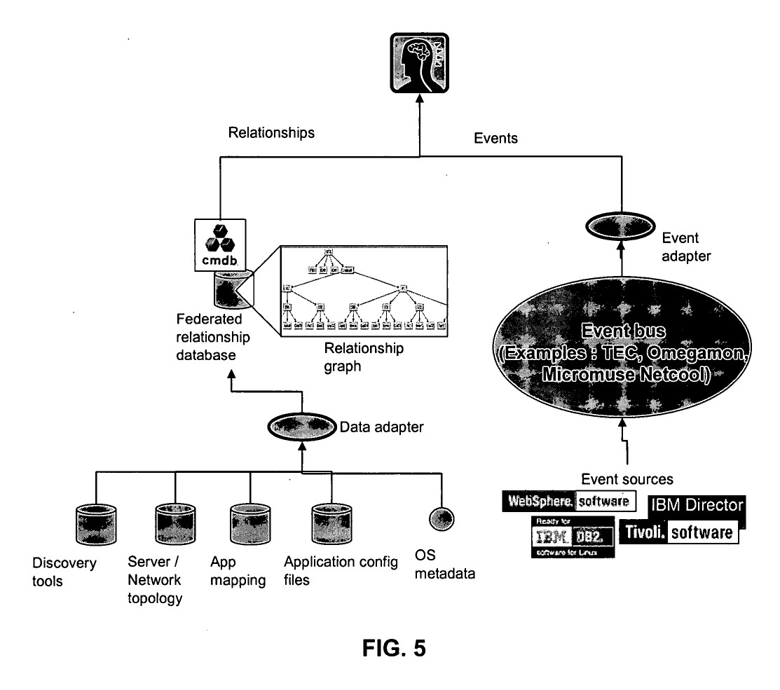

FIG. 5 is a diagram illustrating the general functional information flow with respect to an the present invention. The diagram of FIG. 5 is essentially organized into two related sub-functions. In particular, the system configuration graph generation portion of the invention, as discussed above in FIGS. 1-4 is shown on the left-hand side of FIG. 5. The event identifying portion is on the right-hand side of FIG. 5.

As shown on the left side, data, such as that which is generated and stored by discovery tools like those discussed above, server/network topology files, application mapping files, application configuration files and operating system metafiles, is accumulated and processed by a data adapter. From the adapter, the data is provided to a configuration management database (cmdb) where a relationship graph is generated. Once the system configuration graph is generated, it is provided to the resolver.

Additionally, on the right side of FIG. 5, events are recognized and logged by specialized event source applications such as Websphere, IBM Director, which is an element management system (EMS), Tivoli, etc. Data logged by the event sources is provided to an event bus, which comprises applications such as the OMEGAMON, etc. An event adapter receives an output from the event bus and passes it to the resolver.

The resolver then overlays the event data over the configuration graphical data and stores the updated graph. The updated graph is then repeatedly updated with additional data over time as the system runs various processes and various events occur. Ultimately, when a user desires to resolve a particular undesirable event or system failure, he or she enters relevant parameters, such as those discussed above, and the stored graphical data is searched to find any similar events that occurred with the same system configuration, as determined by analyzing the graphical data.

An embodiment of the invention takes the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. In particular, the program code provided on the computer-readable medium includes the functions described above with respect to the formation of a graphical representation of an IT system and various events that occur within the system as a result of different processes running.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It would be understood that a method incorporating any combination of the details mentioned above would fall within the scope of the present invention as determined based upon the claims below and any equivalents thereof.

Other aspects, objects and advantages of the present invention can be obtained from a study of the drawings, the disclosure and the appended claims.

What is claimed is:

1. A method for capturing and reusing intellectual capital regarding an IT system, the method comprising:
generating a graphical representation of a relationship between hardware and software components of the IT system;
identifying event data that is descriptive of a first undesirable event relative to the IT system;
associating the event data identified with the graphical representation of the relationship between hardware and software components of the IT system to create an updated system graph;
inputting data representative of a second undesirable event; and
comparing the updated system graph to the inputted data to at least partially resolve the second undesirable event.

2. A method as claimed in claim 1, wherein said generating comprises determining at least one of a static and a dynamic relationship between at least one of the hardware and software system components.

3. A method as claimed in claim 2, wherein at least one static relationship is determined by analyzing a stored configuration file corresponding the IT system.

4. A method as claimed in claim 2, wherein at least one dynamic relationship between system components is determined by running a middleware software application.

5. A method as claimed in claim 2, wherein the at least one of a static and a dynamic relationship between system components is determined by running a network management software application.

6. A method as claimed in claim 1, further comprising:
inputting natural language annotation data regarding the first undesirable event;
including the natural language in the updated system graph;
inputting natural language data regarding the second undesirable event; and
comparing the natural language annotation data regarding the first undesirable event to the natural language data regarding the second undesirable event to at least partially resolve the second undesirable event.

7. A method as claimed in claim 1, wherein the event data identified that is descriptive of the first undesirable event is obtained from a log portion of a middleware program.

8. A method for managing a change in a first IT system, the method comprising:
generating a graphical representation of a relationship between hardware and software components of a second IT system;
identifying event data that is descriptive of a first undesirable event relative to the second IT system;
overlaying the event data identified onto the graphical representation of the relationship between hardware and software components of the second IT system to create an updated system graph;
inputting data representative of a desired change to the first IT system;
comparing the updated system graph to the inputted data; and
determining whether the desired change to the first IT system is viable based on results of the comparison of the updated system graph to the inputted data.

9. A method as claimed in claim 8, wherein said generating comprises determining at least one of a static and a dynamic relationship between at least one of the hardware and software system components.

10. A method as claimed in claim 9, wherein at least one dynamic relationship between system components is determined by running a middleware software application.

11. A method as claimed in claim 9, wherein the at least one of a static and a dynamic relationship between system components is determined by running a network management software application.

12. A computer program product for providing a service to reuse IT system knowledge, the program product comprising:
a computer readable medium;
first program instruction means for generating a graphical representation of a relationship between hardware and software components of the IT system;
second program instruction means for identifying event data that is descriptive of a first undesirable event relative to the IT system; and
third program instruction means for overlaying the identified event data onto the graphical representation of the relationship between hardware and software components of the IT system to create an updated system graph.

13. A computer program product as claimed in claim 12, the program product further comprising:
fourth program instruction means for facilitating the input of data representative of a second undesirable event;
fifth program instruction means for facilitating a comparison of the updated system graph to the inputted data to resolve the second undesirable event.

14. A computer program product as claimed in claim 12, the program product further comprising:
fourth program instruction means for analyzing at least one of a static and a dynamic relationship between system components.

15. A database for providing information regarding an IT system, the database comprising:
a first portion for providing information regarding a relationship between at least one of hardware and software components of the IT system; and
a second portion for providing information regarding an association between at least one event and the at least one of hardware and software components.

16. A database as claimed in claim 15 further comprising a third portion for providing a natural language annotation including information regarding the at least one event.

17. A database as claimed in claim 15, wherein the database portions are arranged in a graphical format that is conducive for structured searching.

18. A system for resolving an undesirable event in an IT network, the system comprising:
a first graph generating portion operable to generate a graphical representation of relationships between at least one of hardware and software components of the IT network;
an event identification portion operable to identify a first undesirable event that has occurred within the IT network; and
a resolver portion comprising at least an association portion operable to associate the first undesirable event with at least one component within the graphical representation of the at least one of hardware and software components of the IT network.

19. A system as claimed in claim 18, wherein the resolver further comprises an event resolution portion operable to determine a resolution of a second undesirable event from the graphical representation.

20. A system as claimed in claim 18, wherein the association portion of said resolver comprises an interface portion operable to interface with at least one middleware process and receive data relevant to the relationships between at least one of hardware and software components of the IT network.

21. A system as claimed in claim 18, wherein the graph generating portion comprises an interface portion operable to interface with at least one middleware process and receive data relevant to the first undesirable event.
